(19) United States
(12) Patent Application Publication
(10) Pub. No.: US 2009/0259444 A1
(43) Pub. Date: Oct. 15, 2009

(54) Method and/or device for controlling and/or monitoring the movement of industrial machines

(76) Inventors: Stefan Dolansky, Altdorf (DE); Roland Schneider, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/991,185

(22) PCT Filed: Aug. 2, 2006
(86) PCT No.: PCT/EP2006/064947

§ 371 Date: Feb. 28, 2008

(30) Foreign Application Priority Data
Sep. 9, 2005 (DE) 102005043022.8

(51) Int. Cl. G06G 7/66; G06F 17/10

(52) U.S. Cl. 703/2; 703/7

(57) ABSTRACT

There is described a method for controlling and/or monitoring a movement of a free body in an industrial machine, wherein the industrial machine comprises an actuator for carrying out a movement, wherein the movement of at least one free body is either mechanically coupled to the movement of the actuator and/or is decoupled from the movement of the actuator. At least one of the following physical variables of the free body: weight, density, frictional parameters, geometric form and/or center of gravity is input into a simulation program, whereupon with the aid of at least one of these physical variables, the movement of the free body is simulated, wherein the simulation takes place, in particular, in real time. This enables a better simulation of dynamic and/or static processes in an industrial machine.

### CROSS REFERENCE TO RELATED APPLICATIONS

This application is the US National Stage of International Application No. PCT/EP2006/064947, filed Aug. 2, 2006 and claims the benefit thereof. The International Application claims the benefits of German application No. 10 2005 043 022.8 DE filed Sep. 9, 2005, both of the applications are incorporated by reference herein in their entirety.

### FIELD OF INVENTION

The present invention relates to a method for operating an industrial machine and for simulating the operation of an industrial machine. An industrial machine may be, for example, a machine tool, an automatic handling device or a production machine. Machine tools are provided, for example, for the processing of workpieces. The processing involves, for example, turning, milling and/or grinding of a workpiece. These types of processing in machine tools can therefore be either cutting or non-cutting. Examples of production machines are plastics injection molding machines, bag forming, filling and sealing machines, printing machines, wood working machines, conveyor belts and the like. Further examples of industrial machines are handling devices, for example, welding robots and lifting devices, for example, cranes. Both handling devices and lifting devices can be used, for example, for assembly work or handling work, such as the sorting of products into a container.

### BACKGROUND OF INVENTION

Industrial machines of these types are subject to ever increasing demands for greater utilization of capacity or more economical use. In the production of goods (e.g. plastics injection molded parts) and/or services (e.g. transport by a crane), the following trends are becoming increasingly apparent:
more complex, highly automated production machines and production equipment (e.g. printing machines)
risk of increasing unproductive periods, for example, for planning, design, commissioning, optimizing

With the aid of simulation, attempts are being made to reduce unproductive times. A simulation is herein understood to mean the recreation of, in particular, a dynamic process in a system with the aid of a model. It is intended, by this means, to gather knowledge that can be transferred to reality. In particular, the model allows a type of “virtual experiment” to be performed similarly to an experiment on the real machine. Advantageously, all the sensitive influencing factors (e.g. physical properties) can be adjusted and the effects on the behavior of the machine can be ascertained.

In the prior art, in order to reduce unproductive periods, activities such as commissioning, error diagnosis, training and/or optimizing to gain expertise are no longer carried out only on real industrial machines, but on virtual industrial machines. Thus the behavior of real industrial machines is simulated. The simulation of particular functions of an industrial machine can also be simulated component by component with the aid of software modules. This component-based simulation means that the industrial machine to be simulated is divided into functional components and modeled, for example, in advance of creating a simulation model. In a simulation system used for this, the behavior of each of these components and the interaction between the individual functional components relevant to the simulation of the industrial machine must be described mathematically. From this, a virtual depiction of the overall industrial machine or plant can be formed. The term plant should be understood to mean an industrial machine wherein at least two industrial machines or at least two automation components interact and comprise a larger industrial machine.

### SUMMARY OF INVENTION

With the aid of a simulation, for example, the following behavioral modes of an industrial machine can be simulated:
logical behavior (e.g. binary signals for sensors, limit values, position values, . . . )
regulation behavior (e.g. the reaction of a control device to a change in target value)
controlled motion behavior (e.g. movement caused by electric motors, movements transmitted by gearing, . . . )

The physical principles underlying the behavior of the industrial machine are translated, through a model-creation process, into an abstract simulation model. This means that the behavior of the real electric machine is interpreted in order to reduce it to technical and physical principles.

The model of the industrial machine according to physical principles is based on a mathematical description of individual components whose interaction is already known. A known interaction relates, for example, to the speed of rotation of a roller which is driven by an electric motor, via a gearbox.

It is an object of the present invention to provide a method and a device which gives a better simulation of dynamic and/or static processes in an industrial machine and/or improves the use of the industrial machine through a simulation.

According to the invention, this object is achieved with a method having the features as claimed in an independent claim and/or a device having the features as claimed in a further independent claim. The subclaims relate to advantageous, non-obvious developments of the invention.

The method according to the invention relates to the control and/or monitoring of a movement of a free body in an industrial machine. The term control herein also includes regulation processes. The control and/or the monitoring are taken on, for example, by a control system, wherein the control system can also be provided for carrying out regulation functions. In relation to a device for controlling and/or regulating, the term control is also used below as a synonym for a regulating apparatus. The industrial machine has an actuator for performing a movement. An example of an actuator is an electric machine, such as a direct current motor, a synchronous motor, an asynchronous motor or a linear motor. A further example of an actuator is a hydraulically or pneumatically driven piston. In a further step of a grouping together of functions, a conveyor belt driven by an electric machine is also an actuator. The free body is an object which cannot be kept on a forced movement path by an actuator of the industrial machine alone or by other means of the industrial machine. An example of a body which is held on a forced movement path is a printing cylinder of a printing machine, which is driven by an electric motor, either directly or indirectly via a gearbox and is forced by means of bearings into a rotary movement path. Another example of a forced movement is a linear drive wherein, for example, the primary part is moved by a linear guide over a secondary part.

An industrial machine as described in the text above, for example a production machine, a machine tool, a handling device or a lifting device, apart from having bodies which are moved on a forced movement path by an actuator of the industrial machine, can also have free bodies. Free bodies of this type are either mechanically coupled to the movement of the actuator in the industrial machine and/or their movement is decoupled from the actuator of the industrial machine. Examples of free bodies with coupling of the movement of the free body to the actuator are bodies on a conveyor belt, for example, bottles, jars, boxes or the like. Free bodies of this type on the conveyor belt are, in particular, free from restraints which keep the conveyed goods, that is the free bodies, on a forced movement path. In most configurations, the free body is held on the conveyor belt or a conveying apparatus only by the friction produced between the free body and the conveyor belt by gravity. The free body follows the movement of the conveyor belt, in particular, only insofar as, for example, centrifugal forces or inertial forces do not counteract the joint, even movement. The gravity of the earth is used in the simulation as a parameter for simulating the movement of the free body. The acceleration due to gravity g is approximately 9.81 m/s².

In a further embodiment of the industrial machine, the free body is decoupled from the movement of the actuator. This decoupling occurs in machine tools, for example during cutting production steps. During milling or turning of a workpiece, chips are produced which are able to move as free bodies away from the workpiece. This movement may originate from the movement of the actuator, but the movement of the free body, in particular the chips after their removal from the workpiece, is no longer influenced by the actuator of the industrial machine. However, active influencing occurs when the chips are blown by an air stream and thereby, a direction of fall is altered. This influence can also be simulated, although for this, parameters such as the chip size and weight are included in the simulation.

A further example of free bodies whose movement is decoupled from the actuator of the industrial machine is the fillings in bag forming, filling and sealing machines. These machines can be used for filling with loose materials, for example, potato crisps or peanuts. Both potato crisps and peanuts fall, due to the gravitational attraction of the earth, into a bag which is open on one side. This falling movement is a falling movement of free bodies, which is decoupled from an actuator of the industrial machine. Coupling would arise, for example, on use of an air stream from a nozzle, wherein the fall of the bodies is influenced by the air stream as an actuator. In the bag forming, filling and sealing machine, the actuator is, for example, an electric motor which, for example, serves to transport the bag or to move welding tongs for sealing the bag.

According to the invention, at least one of the following physical variables is assigned to a free body in a simulation—in particular, a simulation carried out by a simulation program—weight, density, friction parameters, geometric form and/or center of gravity, etc. If a physical variable of this type is input into the simulation program, with the aid of this one or more physical variables, the movement of the free body can be simulated. If, for example, a bottle stands as a free body on a conveyor belt, then using the physical variables of center of gravity and weight and the geometric form, particularly of the foot of the bottle, it is possible to calculate the acceleration with which the conveyor belt can be accelerated without the free body, that is the bottle, falling over. If a variety of bottles are transported on the conveyor belt, then for each bottle, a corresponding maximum acceleration of the conveyor belt can be calculated with the aid of the simulation program.

In an advantageous embodiment of the invention, a simulation of this type is carried out in real time. With a real time simulation of this type, varying boundary conditions can also be taken into account in the real time simulation during the running of the industrial machine. Examples of varying boundary conditions are rotary speeds of actuators or the like which are variable based, in particular, on control algorithms.

In a further advantageous embodiment, real time relates not only to the perception time or reaction time of a person, but also to the real time as it concerns the industrial machine itself. In industrial machines, clock cycles and interpolations can be carried out in the nanosecond, microsecond or millisecond range.

The simulation is advantageously carried out with software which can be executed on control hardware, that is, an apparatus for controlling and/or regulating. Apparatuses of this type include, for example, memory-programmable control systems, regulable and controllable power converters, industrial PCs, CNC control systems, etc.

In a further embodiment, the control hardware has additional simulation hardware which is also used for simulation. The simulation can thus, for example, be accelerated compared with a purely software-based simulation on non-specialized hardware, or the hardware not specialized for the simulation can be freed up. In an advantageous embodiment of the method, a physics simulator is used. This physics simulator can be linked advantageously to a graphical representation, so that a user can perceive the simulation results with regard to the representation of the position of an either moving or non-moving free body, in particular, in real time.

In a further advantageous embodiment, the simulation results are passed to further software or hardware systems or made available to an operator of the industrial machine. Based on the properties of inanimate matter and on the forces acting on this matter, the physics simulator calculates the movements and interactions evoked, taking account of the physical principles that apply. It therefore serves to represent simple physical circumstances and enables the construction of a simplified virtual image of the environment.

Advantageously, a representation of the simulation results can be made in a three-dimensional form. An advantageous use of the three-dimensional representation in conjunction with the physics simulator allows the use of three-dimensional geometric dimensions for the simulation of physical principles. This concerns, for example, the use of a gripper arm with a bottle, wherein the gripper arm engages, for example, in a narrowing of a bottle neck such that a gripper arm has a smaller diameter than a bottle neck. The bottle with the bottle neck then lies, under the effect of gravity, on the gripper arm. The gripper arm thus grips the bottle in a type of constriction of the bottle by which the bottle neck is formed. With the simulation, the extent to which gripping elements of the gripper arm need to move toward one another for the bottle to be gripped may be calculated.

The use of the method according to the invention or use of the physics simulator further allows the industrial machine to be depicted not only through a description of its behavior or the behavior of individual components, but to make the behavior of this industrial machine dependent on physical properties of free bodies that interact with the industrial machine. It is herein significant for the simulation of the interaction to use physical variables such as density, geometric dimensions, the degree of damping, the modulus of elasticity (Young's modulus) and frictional parameters in the simulation. The Young's modulus is a physical property of a substance (material) which states how the substance compresses and stretches under mechanical loading. With the aid of the Young's modulus, it is also possible, for example, to create a relationship between a deformation and a stress. The degree of damping is a physical property of a substance which denotes how much energy the substance absorbs when it is stretched or compressed (deformed).

In a further advantageous embodiment, for the simulation, additional physical properties which vary over time are used. This involves, for example, forces which act with varying intensity on the free body, depending in different ways on the condition of the industrial machine.

By means of a simulation of the individual components of an industrial machine, together with their physical properties, the real behavior of the industrial machine to be simulated is revealed in an advantageous manner. This is achieved through the use of a simulation program which is executed, in particular, as a physics simulator. For example, by this means a material flow within an industrial machine can be simulated automatically using the defined physical properties. In an advantageous embodiment, it is possible to input defined interactions between the individual components of the industrial machine. With the use of real time-capable simulations, it is possible for the operator to be shown the behavior of the industrial machine in real time as a virtual machine and, in this way, to receive a depiction of a real behavior.

Through the depiction of individual components of the industrial machine with their physical properties in a physics simulator, in advantageous manner, a behavior of the industrial machine that is to be simulated emerges, wherein in particular, a material flow is automatically integrated into the simulation by maintaining the physical laws. It is also possible to define the behavior of free bodies in relation to one another and their behavior in relation to the industrial machine by their physical properties. Thus a simulation of the interaction of the free bodies among themselves and of a free body to the industrial machine is possible.

A variety of advantages relating to the simulation of movements are possible, some of which are set out below by way of example:
simulation of stochastic behavior, such as the process of filling a container, wherein bulky bodies are used for the filling
simple consideration of flexible objects in an industrial machine (e.g. fabrics, cables, foam, . . . )
very rapid model representation without the necessity for understanding the behavior of the industrial machine, since:
   a) the behavior of the machine is automatically defined on the basis of the defined physical properties and the existing principles;
   b) even the machine states that are not foreseeable by model makers, or unforeseeable machine behavior can be simulated with the aid of the simulation of physical processes and/or
   c) the time saving from the simulation is not consumed again by long-winded model making.
a calculation and 3-D visualization that is optimized for speed and particularly for real time, by means of which the interplay of the simulation with hardware (e.g. a control system or a part of the industrial machine) and the operator thereof is made possible (hardware in the loop).

“Hardware in the loop” (HIL) stands for a configuration of the simulation wherein, apart from software programs, actual objects can also be used. This may involve, for example, control systems which are involved, as hardware, in the simulation. Drive regulators, however, are represented, for example, purely with software that can run on a PC. The main effect of the HIL simulation is that the hardware runs at a fixed speed (clocking) and all other components involved in the simulation must also run at this speed. This enables real time requirements to be met. But, in order to achieve real time behavior, by means of porting, the control system can also be reproduced entirely in software. This is realized, for example, in a virtual NCK (VNCK—virtual numerical control kernel). Another possibility suggests itself through synchronization of the control system with a software clock pulse. Both approaches can also be realized with the physics simulator. The counterpart to HIL, with only software components, is often designated “software in the loop” (SIL).

In a further advantageous embodiment of the method according to the invention, a target movement is defined for the movement of the free body, according to which the simulated movement is compared with the target movement, after which in the case, particularly, of a deviation of the simulated movement from the target movement, an action is initiated. An action is, for example, a change of target values such as a speed, an acceleration or the like.

A target movement is given, for example, for the transportation of transported goods on a conveyor belt by the conveyor belt. Given proper functioning of the conveyor belt and the transportation of the transported goods, the speed and the movement direction of the conveyor belt match those of the transported goods. If the transported goods are changed so that, for example, in place of containers with a low center of gravity, that is, a center of gravity close to the conveyor belt, goods with a greater distance between the center of gravity and the conveyor belt are transported, then it is possible for the transported goods to tip over, since the accelerating forces are too great. By inputting the physical variables for the transported goods into the simulation and by including the speed or acceleration values of the conveyor belt in the simulation, it is then possible to ascertain the possible deviation of the target movement from the actual movement of the transport goods on the conveyor belt. Thus, for example, it can be shown in advance on an HMI (human machine interface), that is before actual operation of the industrial machine, that, for example, transported goods as free bodies on the conveyor belt will fall over under certain boundary conditions (acceleration, curve radius, . . . ). If such behavior is detected, then, for example, an alarm or a warning signal can be generated. The planning of software for controlling and/or regulating the industrial machine can then be adjusted, for example, automatically. This automatic adjustment relates, in particular, to reducing target values or the speed for the acceleration.

In a further advantageous embodiment of the invention, a deviation of this type of the simulated actual movement from the target movement is used for correcting boundary conditions. A correction of this type concerns, for example, the target speed of a conveyor belt or a target variable (in particular a speed or an acceleration) of the industrial machine. The target variable is an example of a parameter of the control system for the industrial machine wherein the control system can also be carried out as a regulator.

In a further embodiment, the simulation of the physical processes is carried out in the apparatus for controlling and/or regulating the industrial machine.

Advantageously, alongside the movement of the free body, a rest position of the free body is also calculated. The rest position relates, in particular, to an end point of the simulated movement of the free body. Advantageously, the result of the simulation is used to calculate a geometric variable wherein the geometric variable is used for simulating a space. It is thereby possible, for example, to simulate how free bodies come to lie upon one another when, for example, a container is filled as a space. A further example of this is also the calculation of the position, for example, of chips in a machine tool. In that the trajectory and the size of the chips can be calculated from known parameters such as the rotary speed of a spindle in a lathe, the position and the cutting angle of a tool and the cutting depth, it is possible therefrom to simulate where the removed chips will fall and when, for example, the industrial machine needs to be cleaned. A further advantage in this regard would be that, at the stage of designing the industrial machine and without any previous practical investigation, the space in which the chips fall can be configured such that the smoothest possible functioning of the industrial machine can be guaranteed without the functioning of the industrial machine being impaired by the chips produced.

It is particularly advantageous also to visualize simulation results of this type for movement and for static collections of free bodies. This applies, for example, to the positions of bottles that have fallen off a conveyor belt. If all the bottles fall off the conveyor belt in the same place, then a heap of bottles forms. This heap of bottles can be simulated.

A device according to the invention—also designated an apparatus—for controlling and/or monitoring a movement of a free body in an industrial machine has a physics simulator for the simulation. The industrial machine has an actuator for carrying out a movement, wherein the movement usually relates to a free body. The free body is either mechanically linked to the movement of the actuator and/or is decoupled from the movement of the actuator of the industrial machine. The physics simulator can be realized, for example, as software on an existing control system of the industrial machine. In a further embodiment of the device, the apparatus for controlling and/or regulating the industrial machine has hardware which can be assigned to the physics simulator, said hardware being provided at least for carrying out part of the software of the physics simulator.

In a further embodiment of the device according to the invention, said device has means for visualizing the movement and/or the visualized position of at least one free body, wherein the visualization can be carried out, in particular, in real time. By this means, for example, an operator of an industrial machine can observe in real time on an HMI (human machine interface) the simulated movement of free bodies within or on the industrial machine without the need for a camera. Not only does this reduce the costs, it is also advantageous in areas where the environmental conditions make the operation of cameras difficult (e.g. due to excessive temperatures). Advantageously, the device according to the invention is used in a method according to the invention.

### BRIEF DESCRIPTION OF THE DRAWINGS

The figures that follow show exemplary embodiments of the method and the device according to the invention. Herein:

FIG. 1 shows an embodiment of the invention for a bottle transport apparatus, and

FIG. 2 shows a further application of the invention for a packaging machine.

### DETAILED DESCRIPTION OF INVENTION

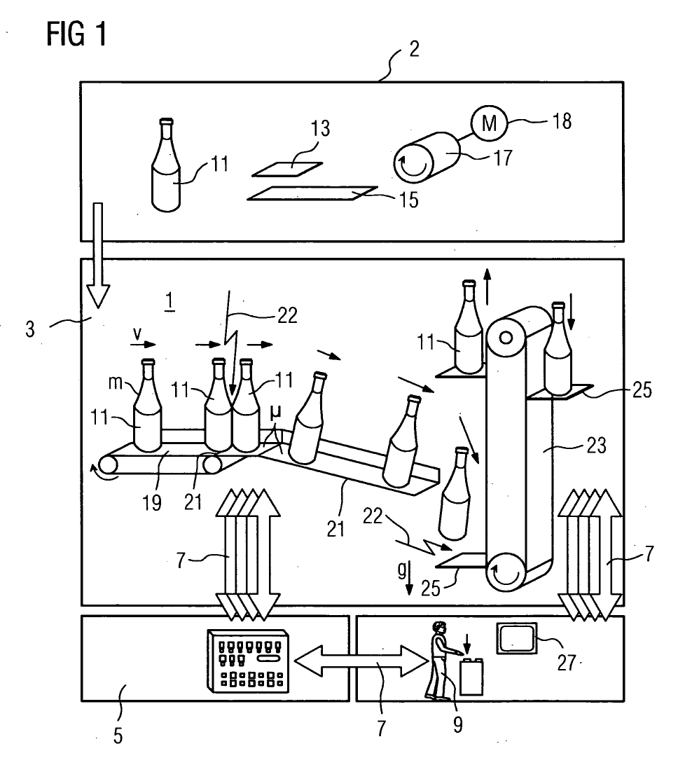

The representation in FIG. 1 shows the modeling and simulation of a transport apparatus for bottles 11. A transport apparatus 1 of this type for bottles 11 is an industrial machine and is used, for example, in a bottle filling apparatus. The bottle filling apparatus is also an example of an industrial machine. In a first step 2 of the method, the parameters for the simulation are defined. This relates, for example, to the geometry of the bottle 11. Apart from the geometry of the bottle 11, for example, the density ρ of the material or its Young's modulus is also stipulated.

Furthermore, the coefficients of friction μ, in particular, are also stipulated. For this purpose, in an advantageous embodiment, the points of application of the forces and other boundary conditions are also determined. The coefficients of friction μ relate both to a surface 13 of a base of the bottle 11 and to a surface 15 of a conveyor belt, wherein both are symbolized by one surface.

The conveyor belt is brought into motion, for example, by a drive roller 17 driven by an electric motor 18. As simulation parameters, communication parameters and interfaces and the spatial arrangement of different components of the industrial machine and the free bodies—bottles—can be defined.

In a further method step 3, the simulation of the transport of the bottles 11 of mass m on a conveyor belt 19 or on various conveyor belts 19, 23 can be carried out and graphically represented, for example, by means of a HMI. According to FIG. 1, the bottles 11 are initially moved on a horizontally arranged conveyor belt 19 at a speed v. At one end 20 of the conveyor belt 19, a simulated collision 22 of the bottles 11 takes place. Through this collision 22 of the bottles 11, the bottles 11 are pushed onto an inclined plane 21. The simulated movement of the bottles 11 is made taking account of the coefficient of friction μ both in the region of the inclined plane 21 and in the region of the collision 22. Due to gravity g, the bottles 11 slide down the inclined plane 21 and meet a vertically oriented transport apparatus 23. The transport apparatus 23 has stand surfaces 25 for the bottles 11. The stand surfaces 25 are moved according to the direction of the arrows, clockwise. Once the bottles 11 have fallen off the inclined plane 21, they meet the stand surfaces 25 so that each bottle 11 collides with the stand surface 25 and comes to a standstill and is then transported in a vertical direction. By means of a physical simulation of the movement processes, the movements of the bottles—free bodies—are simulated taking account of the boundary conditions such as an inclined plane, coefficients of friction and the movement of, for example, the stand surfaces 25. The movement of the conveyor belts 19 and 23 is controlled by a controlling and/or regulating apparatus 5. A communication system 7 is provided for this purpose. A further communication system 7 is provided between the controlling and/or regulating apparatus 5 and an operator 9, wherein the operator 9 can observe the simulation of the movement of the bottles 11, for example, by means of an HMI 27.

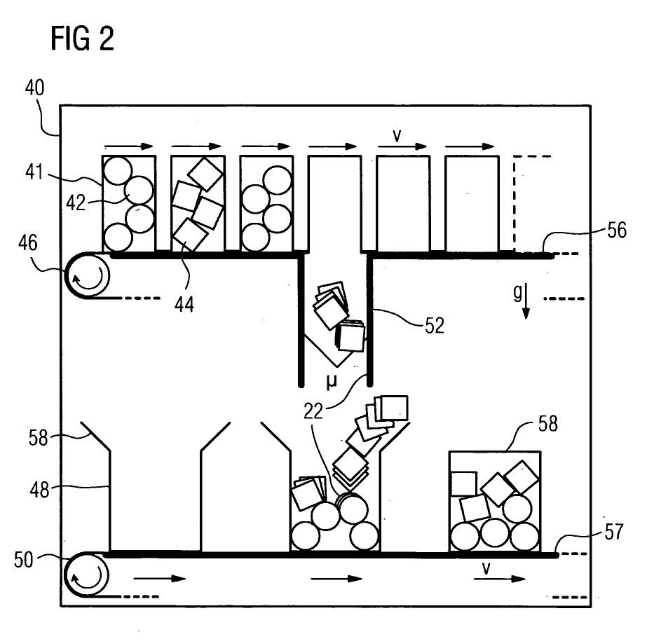

The representation according to FIG. 2 shows another example of the use of the method or the device according to the invention. The representation symbolically shows a packaging machine 40. On a transport apparatus 46, which comprises a conveyor belt 56 with holes, spherical free bodies 42 and cube-shaped free bodies 47 are transported at a speed v in pots 41 which are open in the direction of gravity g. When a pot moves over an opening tube 52, the free bodies 42, 44 fall under gravity g in the direction of a further conveyor belt 57. Knowing the geometry and density of the free bodies 42, 44 and the coefficient of friction μ thereof and of the opening tube 52, the falling movement can be simulated. This relates in particular to the collisions 22 of the free bodies 42, 44 among themselves and the collisions 22 of the free bodies 42, 44 with the opening tube 52. After leaving the opening tube 52, the free bodies 42, 44 fall into the containers 48 which are closable with covers 58, said containers being removed by means of a horizontal transport apparatus 50 on a conveyor belt 57 under the opening tube 52 at a speed v.

1.-10. (canceled)

11. A method for controlling a movement of a free body in an industrial machine, comprising:
providing the industrial machine having an actuator for carrying out a movement, at least providing a simulation program with at least one of the following physical variables of the free body selected from the group consisting of: weight, density, frictional parameter, geometric form, center of gravity, and a combination thereof; and
simulating the movement of the free body based upon at least one of the variables of the free body.

12. The method as claimed in claim 11, wherein the simulation takes place in real time.

13. The method as claimed in claim 11, wherein the movement of at least one free body is mechanically coupled to the movement of the actuator.

14. The method as claimed in claim 12, wherein the movement of at least one free body is mechanically coupled to the movement of the actuator.

15. The method as claimed in claim 11, wherein the movement of at least one free body is mechanically decoupled from the movement of the actuator.

16. The method as claimed in claim 11, wherein a target movement is laid down for the movement of the free body, and wherein simulated movement is compared with the target movement.

17. The method as claimed in claim 14, wherein a target movement is laid down for the movement of the free body, and wherein simulated movement is compared with the target movement.

18. The method as claimed in claim 16, wherein given a deviation of the simulated movement from the target movement an action is triggered.

19. The method as claimed in claim 18, wherein the action triggers a warning signal and/or an alarm signal.

20. The method as claimed in claim 18, wherein the action triggers a parameter change in an apparatus for controlling and/or regulating.

21. The method as claimed in claim 120, wherein the apparatus controls the actuator.

22. The method as claimed in claim 11, wherein for simulation of the movement of the free body gravity is included.

23. The method as claimed in claim 22, wherein a rest position of the free body is calculated.

24. The method as claimed in claim 23, wherein at least one simulation result is used for calculating a geometric variable, and wherein the geometric variable is used to simulate a space.

25. The method as claimed claims 11, wherein the simulation result of the movement of the free body is visualized.

26. The method as claimed claims 23, wherein the rest position of the free body is visualized.

27. A method for monitoring a movement of a free body in an industrial machine, comprising:
providing the industrial machine having an actuator for carrying out a movement, at least providing a simulation program with at least one of the following physical variables of the free body selected from the group consisting of: weight, density, frictional parameter, geometric form, center of gravity, and a combination thereof; and
simulating the movement of the free body based upon at least one of the variables of the free body.

28. A device for controlling and monitoring a movement of a free body in an industrial machine, comprising:
an actuator for carrying out a movement, wherein the movement of at least one free body is mechanically coupled to the movement of the actuator; and
a physics simulator to calculate the movement of the free body.

29. The device as claimed in claim 28, further comprising a visualizing device to display the movement and position of the free body.

30. The device as claimed in claim 29, wherein the free body is a bottle.
